(19) United States
(12) Patent Application Publication
(10) Pub. No.: US 2007/0001111 A1
(43) Pub. Date: Jan. 4, 2007

(54) METHOD AND APPARATUS FOR PROTECTING PERSONNEL USING LASER PROJECTION SYSTEMS

(76) Inventors: Kurt D. Rueb, Kitchener, ON (CA); Marina Matic-Vujovic, Kitchener, ON (CA); Robert Sandness, King City, ON (CA); O. Nicholas Komarnycky, Kitchener, ON (CA)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/379,337

(22) Filed: Apr. 19, 2006

Related U.S. Application Data
(60) Provisional application No. 60/672,718, filed on Apr. 19, 2005.
(60) Provisional application No. 60/753,165, filed on Dec. 22, 2005.

(51) Int. Cl. H01J 3/14

(52) U.S. Cl. 250/236; 250/205

(57) ABSTRACT

A laser projection system having personnel protection utilizes a proximity detector system to detect any approach by an operator or other personnel within a predetermined protection zone. If an approach by personnel is detected within a predetermined zone, the laser output is either interrupted or reduced to a safe level, e.g., such as less than 5 mW, or to a level defined as safe for the detected approach distance. Alternatively, the proximity detector system can also utilize an array of highly directional proximity detectors, infrared detectors, and/or incorporation of a detection mechanism onto the laser projection system frame itself. An electronic circuit directly modifies the output power of the laser projector to an approved level based on feedback of the speed of the scanned beam and the detected closest approach distance.

### CROSS REFERENCE TO RELATED APPLICATION

The instant application claims priority to U.S. Provisional Patent Application Ser. No. 60/672,718, filed Apr. 19, 2005, and U.S. Provisional Patent Application Ser. No. 60/753,165, filed Dec. 22, 2005, the entire specifications of both of which are expressly incorporated herein by reference.

### FIELD OF THE INVENTION

The present invention relates generally to laser projection systems, and more particularly to methods and apparatuses for protecting workers or personnel using laser projection systems, such as but not limited to high output laser projection systems.

### BACKGROUND OF THE INVENTION

Under high ambient light conditions, the output of traditional Class IIIa laser projectors is relatively dim due to safety regulations regarding exposure to laser light sources. Class IIIa is the highest regulated classification of laser projectors allowing access of operators or other personnel to the projection area without protective eyewear or safety guards. Access is limited for prolonged exposure to stationary laser beams of greater than five milliwatts (5 mW) by regulation. However, for scanning laser systems, which are laser projection systems rapidly projecting a pattern or line, higher exposure is possible, provided the period of exposure is very brief, which is defined by regulation as the time required for a laser spot to move across a 7 mm aperture. For example, if the laser beam traverses the aperture in 10 micro seconds, according to the standard, the allowed power increases to more than 50 mW, a 10 times increase in laser output resulting in substantially improved visibility of the laser projection. According to the current standards, this time is evaluated at a distance of four inches in Europe or eight inches in the U.S. from the point of closest access. As the distance from the scanning laser source increases, the time period to cross the aperture decreases proportionally and consequently increases the allowed laser power output level.

As will be understood by those skilled in this art, laser projection systems are now utilized for numerous industrial applications. For example, commonly assigned U.S. Pat. No. 5,646,859, the entire specification of which is expressly incorporated herein by reference, discloses a laser projection system for assembly of components, such as the components of a structural truss assembly. In such applications, the laser projector is mounted opposite a work surface and projects the components of a truss assembly. The components of the truss assembly are then laid upon the projected laser images and assembled, reducing or eliminating errors in assembly and greatly simplifying the assembly of complex trusses and other assemblies. However, because of safety regulations promulgated by the Center for Disease and Radiological Health (CDRH), as well as other regulations, the laser power output must be limited, such that it is difficult for personnel assembling the apparatus to see the projected images under ambient light. This is especially problematic in assembly locations that receive large amounts of ambient light, such as assembly locations that are partially open to the air, thus potentially admitting large amounts of light, such as sunlight, therein.

Thus, it would be desirable to increase the power output of the laser projector in such applications while also protecting personnel having access to the laser projection area.

### SUMMARY OF THE INVENTION

In accordance with the general teachings of the present invention, the methods and apparatuses provide for the protection of personnel using laser projection systems, including but not limited to high output laser projection systems, by either shutting down the laser projector and/or limiting the power to a safe level when personnel come within a predetermined safety range of the laser projector.

In accordance with a first embodiment of the present invention, laser projection system having personnel protection is provided, comprising: (1) a laser projector projecting a laser beam on a work surface including a proximity detector adjacent a source of said laser beam; and (2) a control system operably associated with said proximity detector, wherein said control system is selectively operable to control said laser projector so as to interrupt or reduce power supplied to said laser projector within a safe level when said proximity detector detects personnel within a predetermined distance of said laser projector.

In accordance with one aspect of the present invention, the laser projector may include two proximity detectors adjacent the source of the laser beam as a fail safe operably associated with the control system. By way of a non-limiting example, the proximity detectors may be on adjacent sides of the source of the laser beam.

In accordance with another aspect of the present invention, the laser projector may include a plurality of proximity detectors adjacent to the source of the laser beam as a fail safe operably associated with the control system.

In accordance with still another aspect of the present invention, the proximity detector may be an ultrasonic proximity detector, an infrared detector, may be mounted on a surface of a frame member of the laser projector, and combinations thereof.

In accordance with still yet another aspect of the present invention, the control system may be selectively operable to shut down the laser projector when personnel are detected by the proximity detector within a predetermined distance of the source of the laser beam.

In accordance with a first alternative embodiment of the present invention, a laser projection system having personnel protection is provided, comprising: (1) a laser beam source, wherein said laser beam source is selectively operable to project a laser beam on a work surface; (2) a proximity detector system operably associated with said source of said laser beam; and (3) a control system operably associated with said proximity detector system, wherein said control system is selectively operable to control said laser source so as to interrupt or reduce power supplied to said laser beam source within a safe level when said proximity detector detects personnel within a predetermined distance of said laser beam source.

In accordance with one aspect of the present invention, the proximity detector system may include two proximity detectors adjacent to the laser beam source as a fail safe operably associated with the control system. By way of a non-limiting example, the proximity detectors may be on adjacent sides of said laser beam source.

In accordance with another aspect of the present invention, said proximity detector system may include a plurality of proximity detectors adjacent to the laser beam source as a fail safe operably associated with the control system.

In accordance with still another aspect of the present invention, the proximity detector may be an ultrasonic proximity detector, an infrared detector, may be mounted on a surface of a frame member of the laser beam source, and combinations thereof.

In accordance with still yet another aspect of the present invention, the control system may be selectively operable to shut down the laser beam source when personnel are detected by the proximity detector within a predetermined distance of the laser beam source.

In accordance with a second alternative embodiment of the present invention, a method of controlling a laser projector to protect personnel is provided, comprising: (1) projecting a laser beam on a work surface; (2) using a proximity detector to detect personnel within a predetermined distance of a source of said laser beam; and (3) controlling power to the laser projector to interrupt or reduce said power within a safe level when personnel are detected within said predetermined distance.

In accordance with one aspect of the present invention, the method includes turning off the laser projector when personnel are detected within the predetermined distance.

In accordance with still another aspect of the present invention, the method includes using two independently operable proximity detectors to detect the approach of personnel within the predetermined distance.

In accordance with still yet another aspect of the present invention, the method includes using a plurality of independently operable proximity detectors to detect the approach of personnel within the predetermined distance.

Further areas of applicability of the present invention will become apparent from the detailed description provided hereinafter. It should be understood that the detailed description and specific examples, while indicating the preferred embodiment of the invention, are intended for purposed of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a schematic view of a laser projection system having a personnel protection system, in accordance with a first embodiment of the present invention;

FIG. 2 illustrates a schematic view of a laser projection system having a personnel protection system, wherein an individual is shown approaching the proximity system, in accordance with a first alternative embodiment of the present invention;

FIG. 3 illustrates a schematic view of a laser projection system having a personnel protection system, wherein the individual has been detected by the proximity system, wherein the laser output is either interrupted or reduced to a safe level, in accordance with a first alternative embodiment of the present invention;

FIG. 4 illustrates a schematic view of a laser projection system having a personnel protection system, wherein the individual has traveled beyond the scope of proximity system, wherein the laser output is either resumed or increased to its previous operating level, in accordance with a first alternative embodiment of the present invention;

FIG. 5a illustrates a schematic view of a laser projection system having a first alternative personnel protection system, in accordance with a second alternative embodiment of the present invention;

FIG. 5b illustrates a detailed view of the laser projection system depicted in FIG. 5a, wherein an array of highly directional ultrasonic proximity detectors are employed, in accordance with the second alternative embodiment of the present invention;

FIG. 5c illustrates a graphical view of the laser projection system depicted in FIGS. 5a and 5b, wherein digital processing is performed to ignore echo from known fixed objects in the field of view of the highly directional ultrasonic proximity detectors, in accordance with the second alternative embodiment of the present invention;

FIG. 6 illustrates a schematic view of a laser projection system having a second alternative personnel protection system, in accordance with a third alternative embodiment of the present invention; and

FIG. 7 illustrates a schematic view of a laser projection system having a third alternative personnel protection system, in accordance with a fourth alternative embodiment of the present invention.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

The methods and apparatuses of the present invention utilize a proximity detector system to detect any approach by an operator or other personnel within a predetermined protection zone. By way of a non-limiting example, if an approach by personnel is detected within a predetermined zone, the laser output is either interrupted or reduced to a safe level, e.g., such as less than 5 mW, or to a level defined as safe for the detected approach distance. By “safe,” as that term is used herein, it meant to include any laser power level that is suitable or appropriate for human exposure, e.g., in accordance with applicable industrial safety regulations and/or the like.

By way of a non-limiting example, an electronic circuit directly modifies the output power of the laser projector to an approved level based on feedback of the speed of the scanned beam and the detected closest approach distance.

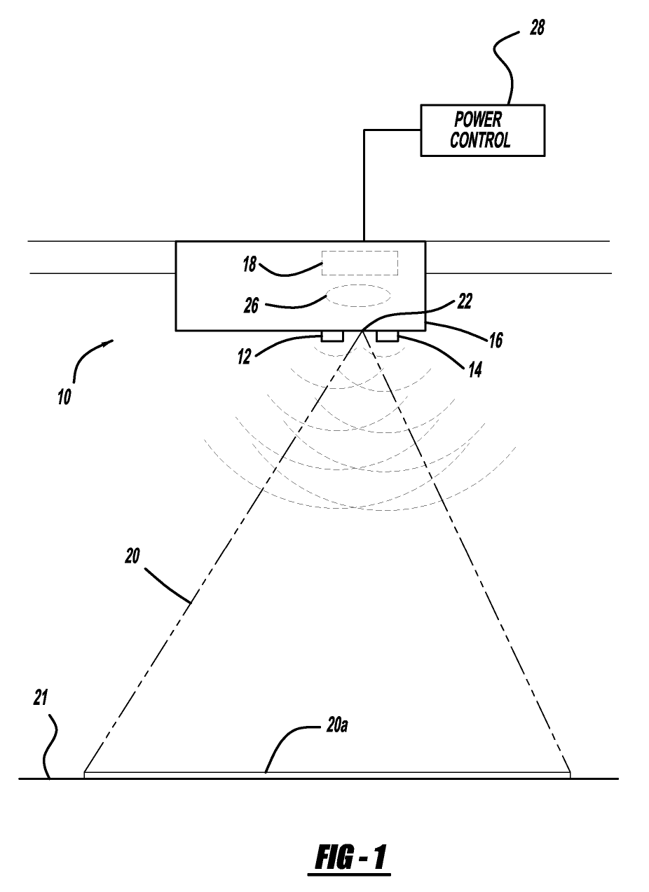

In the embodiment of the apparatus for protection of personnel using a laser projection system 10 of the present invention shown in FIG. 1, two proximity detectors 12, 14, respectively, are mounted on a laser projector cabinet 16 adjacent the source (e.g., laser projector 18) of the scanning laser beam 20 as a fail-safe protection system. The laser beam 20 is operable to form any number of patterns 20a (e.g., straight lines, curved lines, and/or the like) on a work surface 21 (e.g., a floor, platform, wall, ceiling, and/or the like).

As will be understood by those skilled in this art, a laser is typically projected through an aperture 22 from a mirror, such that the “source of the laser beam” is the aperture 22 through which the laser beam 20 is projected in most applications. That is, if one of the proximity detectors 12, 14, respectively, fails or malfunctions, no single point of failure can result in exposure of personnel to unsafe laser power levels.

As shown in FIG. 1, the proximity detectors 12, 14, respectively, may be mounted on opposed sides of the source of the laser beam 20 above and below the aperture 22 of the laser projector 18 or the proximity detectors 12, 14, respectively, may be mounted on opposed sides of the lens 26 or aperture 22 of the laser projector 24. The exact placement of the proximity detectors 12, 14, respectively, is not thought to be critical to the success of the present invention, provided that the proximity detectors 12, 14, respectively, can detect the presence of personnel approaching the source of the laser beam 20 in sufficient time to permit the laser beam 20 to be interrupted or reduced to a relatively safe power level.

It should be appreciated that the present invention permits personnel to freely move about and work on the work surface 21. It is only when the personnel approach too near to the source of the laser beam 20, e.g., the aperture 22, that the proximity detectors, 14, 16, respectively, communicate with the power control 28 such that the laser beam 20 is either interrupted or reduced to a relatively safe power level. For example, if a laser projector 24 is mounted on a wall or a floor, the potential for personnel coming too close to the aperture 22 is relatively high. Even if the laser projector 24 is mounted on a ceiling or a lanyard, the potential for personnel getting too close to the aperture 22 still exists (e.g., personnel climbing ladders to observe the entire work surface 21, unusually tall personnel, and/or the like).

The proximity detectors 12, 14, respectively, may be any conventional proximity detectors, such as ultrasonic proximity detectors, which are connected electrically to the power control 28 of the laser source of the laser projector 24. If an approach by personnel to the laser beam 20 is detected by the proximity detectors, 12, 14, respectively, the laser power output may be turned off or, alternatively, reduced to a safe level, depending upon the distance of the personnel to the laser projector 24. It is also possible to reduce the power output of the laser proportionally to the distance of personnel detected by the proximity detectors 12, 14, respectively, to maintain maximum allowable power to the laser projector 24 while protecting personnel from unsafe exposure to the laser beam 20.

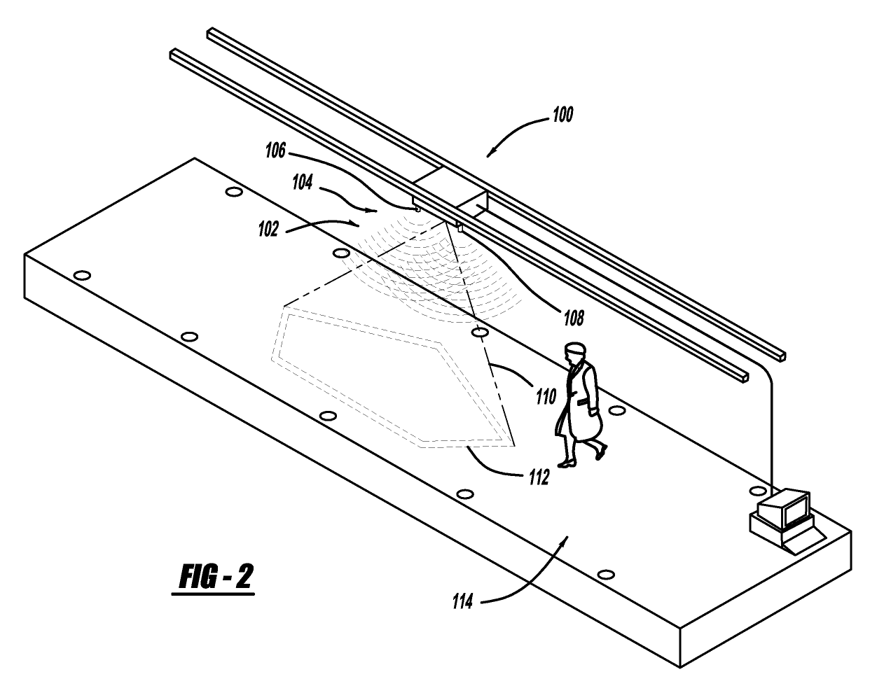

By way of a non-limiting example, reference is made is to FIGS. 2-4 which illustrate a potential use of the present invention.

Referring to FIG. 2, there is shown a schematic view of a laser projection system 100 having a personnel protection system 102 operably associated therewith, wherein an individual is shown approaching the proximity system 104, e.g., proximity detectors 106, 108, respectively. In this view, the proximity detectors 106, 108, respectively, employ ultrasonic technology to detect the presence of personnel; however, it should be understood that other types of proximity detectors may be used in the practice of the present invention. In this view, the output of the laser beam 110, creating pattern 112 on work surface 114, is at a relatively higher level than would be employed if personnel were within the scope of the proximity system 104.

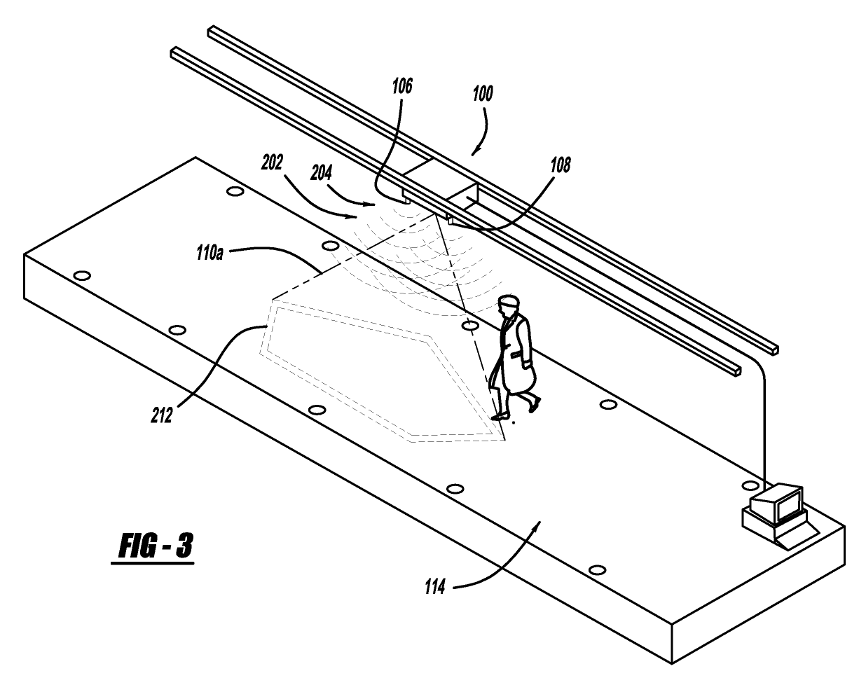

Referring to FIG. 3, there is shown a schematic view of the laser projection system 100 having the personnel protection system 102, wherein the individual 103 has been detected by the proximity system 104, i.e., one of the proximity detectors 106, 108, respectively, wherein the output of the laser beam 110a, creating pattern 112 on work surface 114, is either interrupted or reduced to a safe level, e.g., a lower level than that employed in FIG. 2.

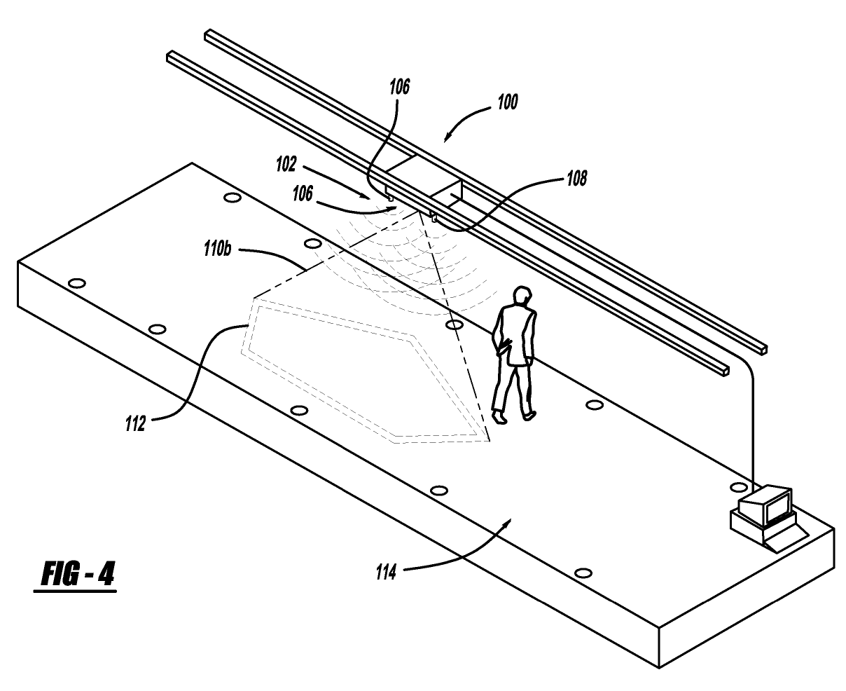

Referring to FIG. 4, there is shown a schematic view of the laser projection system 100 having the personnel protection system 102, wherein the individual 103 has traveled beyond the scope of the proximity system 104, i.e., beyond or outside of the scope of proximity detectors, 106, 108, respectively, wherein the output of the laser beam 110b, creating pattern 112 on work surface 114, is either resumed or increased to its previous operating level, e.g., the same or similar to those power outputs as depicted in FIG. 2.

The method of controlling a laser projector to protect personnel of the present invention thus includes projecting a laser beam on a work surface, then using a proximity detector to detect personnel within a predetermined distance of a source of the laser beam and controlling the laser power of the laser beam to reduce the laser power within a safe level when personnel are detected within the predetermined distance. As set forth above, the laser projection system and method of the present invention is particularly useful for high output laser projectors having a power output of 5 mW or greater to protect personnel in close proximity to the projector from exposure to high intensity laser beams. However, the laser projection system and method of the present invention may be utilized with any conventional laser projector to protect personnel having potential unsafe exposure to the laser beam. The use of two proximity detectors provides a fail-safe laser projection system having an overlapping projection zone, e.g., as shown in FIG. 1. However, the laser projection system of the present invention may also be utilized with a single proximity detector. Although any suitable proximity detector may be utilized with the laser projector and method of the present invention, suitable proximity detectors are readily commercially available from Hobby Engineering of Millbrae, Calif., Part No. SRF04 and others.

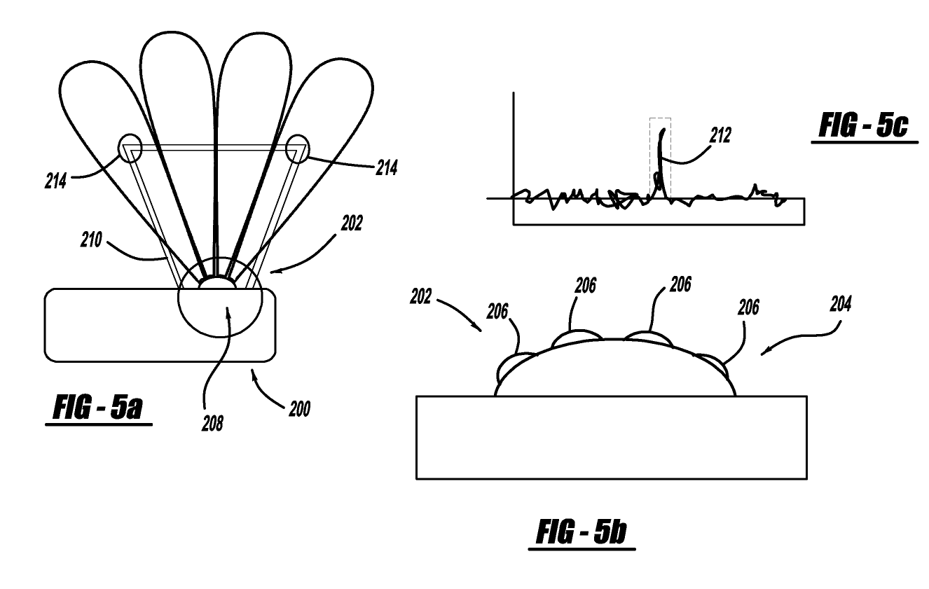

Referring to FIGS. 5a-5c, there is shown a schematic view of a first alternative embodiment of an apparatus for the protection of personnel using a laser projection system 200, wherein the proximity detector system 202 is an array 204 of highly directional proximity detectors 206, such as highly directional ultrasonic proximity detectors, as shown adjacent the source of the laser beam 208. In this embodiment, the laser projector is mounted in a frame assembly 210 which may include laser targets, GPS targets, and/or the like, e.g., as disclosed in co-pending U.S. patent application Ser. No. 10/913,842, filed Aug. 6, 2004, the entire disclosure of which is expressly incorporated herein by reference. As will be understood by those skilled in this art, the frame assembly 210 would provide a “false signal” of the frame if a conventional broad array ultrasonic proximity detector system was used for detection of personnel, e.g., as disclosed in FIG. 1. However, with the array 204 of highly directional proximity detectors 206 shown in the embodiment of this invention (e.g., see FIG. 5b), a control system may be used to “digitize” and ignore the echo 212 produced by fixed objects 214 in the field of view of the detectors, such as but not limited to the frame assembly 210 (e.g., see FIG. 5c). That is, during start up of the laser projection system 200, any fixed objects within the field of view of the sensor array are digitized so that the proximity detector system 202 ignores such fixed objects and controls the laser projector system 200 to either turn off the projector or reduce the laser power to a safe level only if an object which is not located during start up, such as personnel, is detected within the field of view of the detector array.

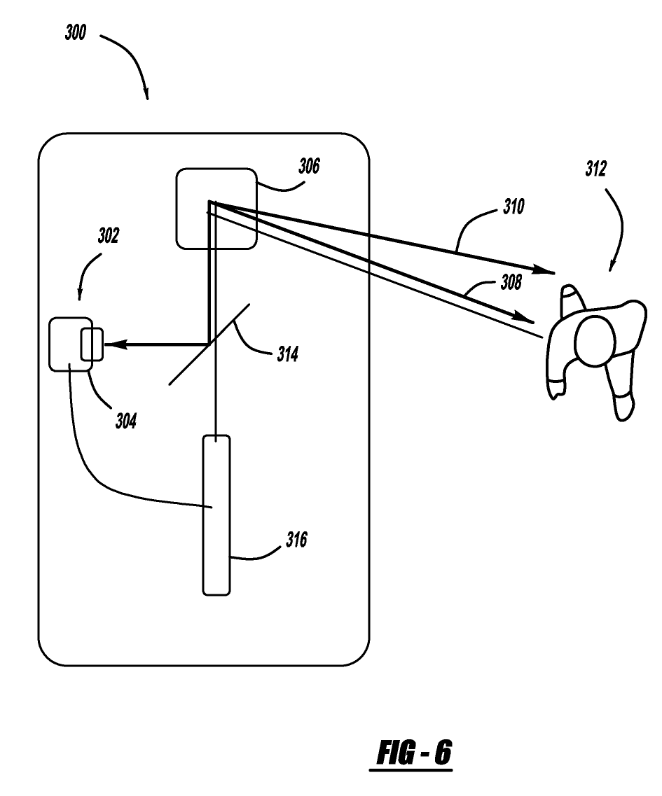

Referring to FIG. 6, there is shown a schematic view of a second alternative embodiment of an apparatus for the protection of personnel using a laser projection system 300, wherein the proximity detector 302 is a passive heat sensor, such as an infrared (IR) heat sensor 304, which detects the heat signature of a human within a predetermined range of the laser projector 306. In the disclosed embodiment, the IR beam 308 is aligned with the laser beam 310 to detect the presence of a heat source, such as an operator 312 and the laser projection system includes an IR sensor 304 and an IR mirror 314 which passes the laser but detects returning heat signature to the IR sensor 304. As described above, the IR sensor 304 is electrically connected to the power source 316 of the laser projector 306 to either turn off the laser projector 306 or reduce the power lever when personnel 312 are detected by the passive heat sensor 304 within a predetermined distance of the laser projector 306. The passive heat sensor 304 may be a conventional IR heat sensor as used in security systems. Alternatively, a more traditional IR security sensor may be used to provide general detection of any heat source close to the laser projector 306.

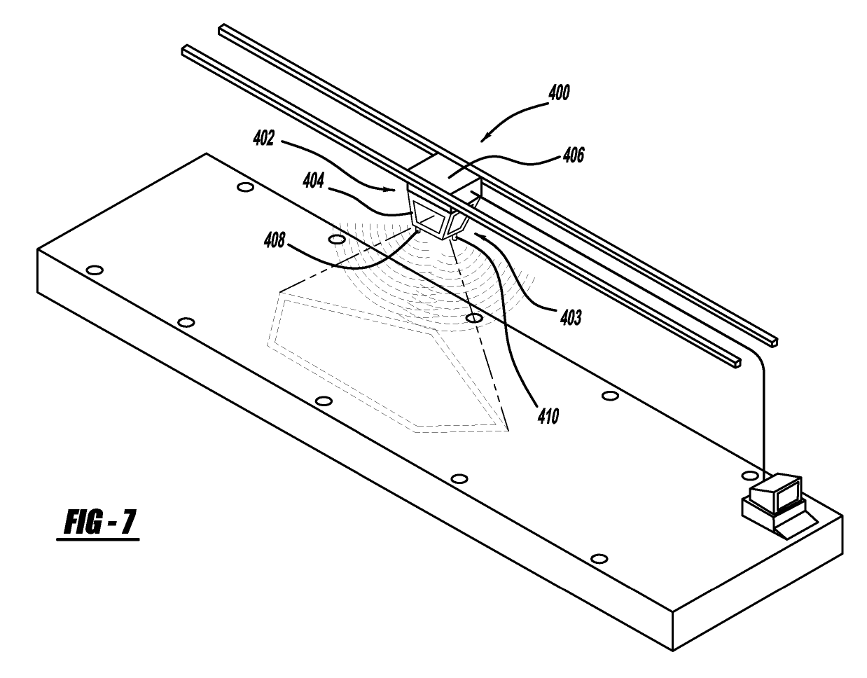

Referring to FIG. 7, there is shown a schematic view of a laser projection system 400 having a third alternative personnel protection system 402. By way of a non-limiting example, a detection mechanism 403 may be incorporated into the frame 404 of the laser beam projector 406. For example, a light curtain across the front of the frame 404 to detect entry and additional light curtains or physical barriers around the side of the frame 404 to prevent access to the area within the frame 404. This could be used in conjunction with proximity detectors 408, 410, respectively, on the front of the frame 404 to extend the protection zone to the standard distance or without modification to prevent only access within three feet of the laser beam projector 406.

As will be understood, other methods of controlling operator access to laser projectors are also possible, including “light shields” or physical barriers, such as fencing. But these methods lack the convenience of the preferred method of the present invention and such safeguards can be overcome or avoided.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A laser projection system having personnel protection, comprising:
a laser projector projecting a laser beam on a work surface including a proximity detector adjacent a source of said laser beam; and
a control system operably associated with said proximity detector, wherein said control system is selectively operable to control said laser projector so as to interrupt or reduce power supplied to said laser projector within a safe level when said proximity detector detects personnel within a predetermined distance of said laser projector.

2. The invention according to claim 1, wherein said laser projector includes two proximity detectors adjacent said source of said laser beam as a fail safe operably associated with said control system.

3. The invention according to claim 2, wherein said proximity detectors are on adjacent sides of said source of said laser beam.

4. The invention according to claim 1, wherein said laser projector includes a plurality of proximity detectors adjacent said source of said laser beam as a fail safe operably associated with said control system.

5. The invention according to claim 1, wherein said proximity detector is an ultrasonic proximity detector.

6. The invention according to claim 1, wherein said proximity detector is an infrared detector.

7. The invention according to claim 1, wherein said proximity detector is mounted on a surface of a frame member of said laser projector.

8. The invention according to claim 1, wherein said control system is selectively operable to shut down said laser projector when personnel are detected by said proximity detector within a predetermined distance of said source of said laser beam.

9. A laser projection system having personnel protection, comprising:
a laser beam source, wherein said laser beam source is selectively operable to project a laser beam on a work surface;
a proximity detector system operably associated with said source of said laser beam; and
a control system operably associated with said proximity detector system, wherein said control system is selectively operable to control said laser source so as to interrupt or reduce power supplied to said laser beam source within a safe level when said proximity detector detects personnel within a predetermined distance of said laser beam source.

10. The invention according to claim 9, wherein said proximity detector system includes two proximity detectors adjacent said laser beam source as a fail safe operably associated with said control system.

11. The invention according to claim 10, wherein said proximity detectors are on adjacent sides of said laser beam source.

12. The invention according to claim 9, wherein said proximity detector system includes a plurality of proximity detectors adjacent said laser beam source as a fail safe operably associated with said control system.

13. The invention according to claim 9, wherein said proximity detector is an ultrasonic proximity detector.

14. The invention according to claim 9, wherein said proximity detector is an infrared detector.

15. The invention according to claim 9, wherein said proximity detector is mounted on a surface of a frame member of said laser beam source.

16. The invention according to claim 9, wherein said control system is selectively operable to shut down said laser beam source when personnel are detected by said proximity detector within a predetermined distance of said laser beam source.

17. A method of controlling a laser projector to protect personnel, comprising:
projecting a laser beam on a work surface;
using a proximity detector to detect personnel within a predetermined distance of a source of said laser beam; and
controlling power to the laser projector to interrupt or reduce said power within a safe level when personnel are detected within said predetermined distance.

18. The invention according to claim 17, wherein said method includes turning off the laser projector when personnel are detected within said predetermined distance.

19. The invention according to claim 17, wherein said method includes using two independently operable proximity detectors to detect the approach of personnel within said predetermined distance.

20. The invention according to claim 17, wherein said method includes using a plurality of independently operable proximity detectors to detect the approach of personnel within said predetermined distance.
